(19) United States
(12) Patent Application Publication
(10) Pub. No.: US 2014/0002599 A1
(43) Pub. Date: Jan. 2, 2014

(54) COMPETITION-BASED MULTIVIEW VIDEO ENCODING/DECODING DEVICE AND METHOD THEREOF

(71) Applicants: Jin Young Lee, Yongin-si (KR); Dong Hyun Kim, Seoul (KR); Seung Chul Ryu, Seoul (KR); Jung Dong Seo, Seoul (KR); Kwang Hoon Sohn, Seoul (KR); Ho Cheon Wey, Yongin-si (KR)

(72) Inventors: Jin Young Lee, Yongin-si (KR); Dong Hyun Kim, Seoul (KR); Seung Chul Ryu, Seoul (KR); Jung Dong Seo, Seoul (KR); Kwang Hoon Sohn, Seoul (KR); Ho Cheon Wey, Yongin-si (KR)

(73) Assignee: SAMSUNG ELECTRONICS CO., LTD., Suwon-si (KR)

(21) Appl. No.: 13/978,609

(22) PCT Filed: Jan. 6, 2012
(86) PCT No.: PCT/KR2012/000136

§ 371 Date: Sep. 16, 2013

(30) Foreign Application Priority Data
Jan. 6, 2011 (KR) 10-2011-0001341
Nov. 30, 2011 (KR) 10-2011-0126950

(51) Int. Cl. H04N 13/00

(52) U.S. Cl. CPC H04N 13/0048
USPC 348/43

(57) ABSTRACT

Disclosed are a competition-based multiview video encoding/decoding device and a method thereof. The competition-based multiview video encoding/decoding device can improve encoding efficiency by determining a prediction vector with the best encoding performance through an extraction of a spatial prediction vector, a time prediction vector, and a viewpoint prediction vector corresponding to a current block.

### TECHNICAL FIELD

The present invention relates to a multi-view video encoding/decoding device and method thereof, and more particularly, to a device and method for encoding/decoding a current block, using a spatial prediction vector, a temporal prediction vector, or a viewpoint prediction vector.

### BACKGROUND ART

A stereoscopic image may refer to a three-dimensional (3D) image for providing form information on depth and space simultaneously. A stereo image may provide an image of different viewpoints to a left eye and a right eye, respectively, while the stereoscopic image may provide an image varying based on a changing viewpoint of a viewer. Accordingly, images photographed from various viewpoints may be required to generate the stereoscopic image.

The images photographed from various viewpoints to generate the stereoscopic image may have a vast volume of data. Thus, implementing the stereoscopic image to be provided to a user may be implausible despite use of an encoding device optimized for single-view video coding, for example, MPEG-2, H.264/AVC, or HEVC, due to concerns about a network infrastructure, a terrestrial bandwidth, and the like.

However, the images photographed from various viewpoints may include redundant information due to an association among such images. Accordingly, a lower volume of data may be transmitted through use of an encoding device optimized for a multi-view image that may remove viewpoint redundancy.

Accordingly, a multi-view image encoding device optimized for generating a stereoscopic image may be necessary. In particular, there is a need to develop technology for efficiently reducing inter-temporal redundancy and inter-viewpoint redundancy.

### DISCLOSURE OF INVENTION

### Technical Solutions

According to an aspect of the present invention, there is provided a multi-view video encoding device, the device including a prediction vector extractor to extract a spatial prediction vector of a current block to be encoded, and an index transmitter to transmit, through a bitstream, an index for identifying the spatial prediction vector of the current block to a multi-view video decoding device.

According to an aspect of the present invention, there is provided a multi-view video encoding device, the device including a prediction vector extractor to extract a temporal prediction vector of a current block to be encoded, and an index transmitter to transmit, through a bitstream, an index for identifying the temporal prediction vector of the current block to a multi-view video decoding device.

According to an aspect of the present invention, there is provided a multi-view video encoding device, the device including a prediction vector extractor to extract a viewpoint prediction vector of a current block to be encoded, and an index transmitter to transmit, through a bitstream, an index for identifying the viewpoint prediction vector of the current block to a multi-view video decoding device.

According to an aspect of the present invention, there is provided a multi-view video encoding device, the device including a prediction vector extractor to extract a spatial prediction vector of a current block to be encoded, a temporal prediction vector, and a viewpoint prediction vector, and an index transmitter to transmit, through a bitstream, an index for identifying a prediction vector to be used in encoding the current block from among the spatial prediction vector of the current block to be encoded, the temporal prediction vector, and the viewpoint prediction vector to a multi-view video decoding device.

According to an aspect of the present invention, there is provided a multi-view video decoding device, the device including an index extractor to extract an index of a prediction vector from a bitstream received from a multi-view video encoding device, and a prediction vector determiner to determine a spatial prediction vector to be a final prediction vector for recovering a current block, based on the index.

According to an aspect of the present invention, there is provided a multi-view video decoding device, the device including an index extractor to extract an index of a prediction vector from a bitstream received from a multi-view video encoding device, and a prediction vector determiner to determine a temporal prediction vector to be a final prediction vector for recovering a current block, based on the index.

According to an aspect of the present invention, there is provided a multi-view video decoding device, the device including an index extractor to extract an index of a prediction vector from a bitstream received from a multi-view video encoding device, and a prediction vector determiner to determine a viewpoint prediction vector to be a final prediction vector for recovering a current block, based on the index.

According to an aspect of the present invention, there is provided a multi-view video decoding device, the device including an index extractor to extract an index of a prediction vector from a bitstream received from a multi-view video encoding device, and a prediction vector determiner to determine a final prediction vector for recovering a current block from among a spatial prediction vector, a temporal prediction vector, and a viewpoint prediction vector, based on the index.

According to an aspect of the present invention, there is provided a multi-view video encoding method, the method including extracting a spatial prediction vector of a current block to be encoded, and transmitting, through a bitstream, an index for identifying the temporal prediction vector of the current block to a multi-view video decoding device.

According to an aspect of the present invention, there is provided a multi-view video encoding method, the method including extracting a temporal prediction vector of a current block to be encoded, and transmitting, through a bitstream, an index for identifying the temporal prediction vector of the current block to a multi-view video decoding device.

According to an aspect of the present invention, there is provided a multi-view video encoding method, the method including extracting a viewpoint prediction vector of a current block to be encoded, and transmitting, through a bitstream, an index for identifying the viewpoint prediction vector of the current block to a multi-view video decoding device.

According to an aspect of the present invention, there is provided a multi-view video encoding method, the method including extracting a spatial prediction vector of a current block to be encoded, a temporal prediction vector, and a viewpoint prediction vector, and transmitting, through a bitstream, an index for identifying a prediction vector to be used in encoding the current block from among the spatial prediction vector of the current block to be encoded, the temporal prediction vector, and the viewpoint prediction vector to a multi-view video decoding device.

According to an aspect of the present invention, there is provided a multi-view video decoding method, the method including extracting an index of a prediction vector from a bitstream received from a multi-view video encoding device, and determining a spatial prediction vector to be a final prediction vector for recovering a current block, based on the index.

According to an aspect of the present invention, there is provided a multi-view video decoding method, the method including extracting an index of a prediction vector from a bitstream received from a multi-view video encoding device, and determining a temporal prediction vector to be a final prediction vector for recovering a current block, based on the index.

According to an aspect of the present invention, there is provided a multi-view video decoding method, the method including extracting an index of a prediction vector from a bitstream received from a multi-view video encoding device, and determining a viewpoint prediction vector to be a final prediction vector for recovering a current block, based on the index.

According to an aspect of the present invention, there is provided a multi-view video decoding method, the method including extracting an index of a prediction vector from a bitstream received from a multi-view video encoding device, and determining a final prediction vector for recovering a current block from among a spatial prediction vector, a temporal prediction vector, and a viewpoint prediction vector, based on the index.

### Effects of Invention

According to an aspect of the present invention, it is possible to enhance encoding efficiency through selecting a candidate for a spatial prediction vector, a temporal prediction vector, and a viewpoint prediction vector with respect to a current block to be encoded, determine a prediction vector having an optimal compression performance, and encode the current block using the determined prediction vector.

### BRIEF DESCRIPTION OF DRAWINGS

FIG. 1 is a diagram illustrating a multi-view video encoding device and an operation of the multi-view video encoding device according to example embodiments.

FIG. 2 is a block diagram illustrating a detailed configuration of a multi-view video encoding device according to example embodiments.

FIG. 3 is a block diagram illustrating a detailed configuration of a multi-view video decoding device according to example embodiments.

FIG. 4 is a diagram illustrating a structure of a multi-view video according to example embodiments.

FIG. 5 is a diagram illustrating an example of a reference picture to be used for encoding a current block according to example embodiments.

FIG. 6 is a diagram illustrating a type of a prediction vector corresponding to a current block according to example embodiments.

FIG. 7 is a diagram illustrating a multi-view video encoding device operating in an inter-mode/intra-mode according to example embodiments.

FIG. 8 is a diagram illustrating a multi-view video encoding device operating in a skip mode according to example embodiments.

FIG. 9 is a diagram illustrating a multi-view video decoding device operating in an inter-mode/intra-mode according to example embodiments.

FIG. 10 is a diagram illustrating a multi-view video decoding device operating in a skip mode according to example embodiments.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

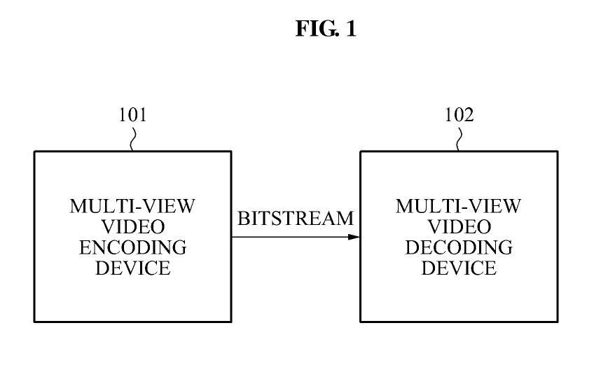

FIG. 1 is a diagram illustrating a multi-view video encoding device 101 and an operation of the multi-view video encoding device 101 according to example embodiments.

The multi-view video encoding device 101 may remove temporal redundancy and viewpoint redundancy more efficiently through defining a new motion vector (MV)/disparity vector (DV) and encoding a multi-view video.

The multi-view video encoding device 101 may encode an input video, based on various encoding modes. Here, the multi-view video encoding device 101 may encode an input video in a frame of which a viewpoint or a time differs from a viewpoint or a time of a frame including a current block to be encoded, using a prediction vector indicating a prediction block most similar to the current block. Accordingly, the more similar the current block and the prediction block, the greater an encoding efficiency achieved by the multi-view video encoding device 101. A result of encoding the input video may be transmitted, through a bitstream, to a multi-view video decoding device 102.

The multi-view video encoding device 101 may enhance an encoding performance of the current block through defining a spatial prediction vector, a temporal prediction vector, and a viewpoint prediction vector to be used for encoding the input video.

Hereinafter, a motion vector (MV) or a disparity vector (DV) associated with the spatial prediction vector, the temporal prediction vector, or the viewpoint prediction vector may be defined as follows. An MV of a predetermined block may be determined in a frame for which a time differs from a time of a frame including the predetermined block, based on a prediction block indicated by the predetermined block. Also, a DV of a predetermined block may be determined in a frame of which a viewpoint differs from a viewpoint of a frame including the predetermined block, based on a prediction block indicated by the predetermined block.

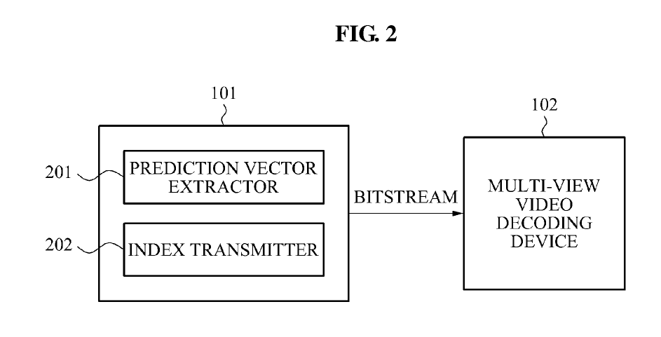

FIG. 2 is a block diagram illustrating a detailed configuration of a multi-view video encoding device 101 according to example embodiments.

Referring to FIG. 2, the multi-view video encoding device 101 may include a prediction vector extractor 201 and an index transmitter 202.

Hereinafter, the multi-view video encoding device 101 operated based on four example embodiments will be discussed.

### Example Embodiment 1

The prediction vector extractor 201 may extract a spatial prediction vector of a current block to be encoded. Here, the spatial prediction vector of the current block may be extracted using a frame including the current block.

In an example, the spatial prediction vector may include at least one of a first MV corresponding to a left block of the current block, a second MV corresponding to an upper block of the current block, a third MV corresponding to an upper left block of the current block, a fourth MV corresponding to an upper right block of the current block, and a fifth MV obtained by applying a median filter to the first MV, the second MV, the third MV, and the fourth MV.

In another example, the spatial prediction vector may include at least one of a first DV corresponding to a left block of the current block, a second DV corresponding to an upper block of the current block, a third DV corresponding to an upper left block of the current block, a fourth DV corresponding to an upper right block of the current block, and a fifth DV obtained by applying a median filter to the first DV, the second DV, the third DV, and the fourth DV.

When the spatial prediction vector is extracted, the index transmitter 202 may transmit, through a bitstream, an index for identifying the spatial prediction vector of the current block to the multi-view video decoding device 102.

### Example Embodiment 2

The prediction vector extractor 201 may extract a temporal prediction vector of the current block to be encoded. Here, the temporal prediction vector of the current block may be extracted, using a frame disposed at a position differing from a position of a frame including the current block at a predetermined time.

In an example, the temporal prediction vector may include an MV or a DV of a target block disposed at a position identical to a position of the current block in a frame corresponding to a time different from a time of a frame including the current block. In particular, when the current block is located at (x, y) coordinates of a frame 1, the temporal prediction vector of the current block may include an MV or a DV of a target block is located at (x, y) coordinates of a frame 2 for which a time differs from a time of the frame 1.

In another example, the temporal prediction vector may include an MV or a DV of surrounding blocks adjacent to a target block disposed at a position identical to a position of the current block in a frame corresponding to a time different from a time of a frame including the current block. In particular, when the current block is located at (x, y) coordinates of the frame 1, the temporal prediction vector of the current block may include an MV or a DV of surrounding blocks adjacent to a target block located at (x, y) coordinates of the frame 2 for which a time differs from a time of the frame 1. Here, the surrounding blocks may include an upper block of the target block, a left block of the target block, an upper right block of the target block, or an upper left block of the target block.

In still another example, the temporal prediction vector may include an MV or a DV of a target block most similar to the current block in a frame corresponding to a time different from a time of a frame including the current block. Here, the target block most similar to the current block may refer to a block highly relevant to a pixel property, and a position of the current block.

When the temporal prediction vector is extracted, the index transmitter 202 may transmit, through a bitstream, an index for identifying the temporal prediction vector of the current block to the multi-view video decoding device 102.

### Example Embodiment 3

The prediction vector determiner 201 may extract a viewpoint prediction vector of the current block to be encoded. Here, the viewpoint prediction vector of the current block may be extracted, using a frame disposed at a different position in terms of a viewpoint from a position of a frame including the current block.

In an example, the viewpoint prediction vector may include an MV or a DV of a target block disposed at a position identical to a position of the current block in a frame corresponding to a viewpoint different from a viewpoint of a frame including the current block. In particular, when the current block is located at (x, y) coordinates of a frame 1, the viewpoint prediction vector of the current block may include an MV or a DV of a target block located at (x, y) coordinates of a frame 2 of which a viewpoint differs from a viewpoint of the frame 1.

In another example, the viewpoint prediction vector may include an MV or a DV of surrounding blocks adjacent to a target block disposed at a position identical to a position of the current block in a frame corresponding to a viewpoint different from a viewpoint of a frame including the current block. In particular, when the current block is located at (x, y) coordinates of the frame 1, the viewpoint prediction vector of the current block may include an MV or a DV of the surrounding blocks adjacent to a target block located at (x, y) coordinates of a frame 2 for which a time differs from a time of the frame 1. Here, the surrounding blocks may include an upper block of the target block, a left block of the target block, an upper right block of the target block, or an upper left block of the target block.

In still another example, the temporal prediction vector may include an MV or a DV of a target block most similar to the current block in a frame corresponding to a viewpoint different from a viewpoint of a frame including the current block. Here, the target block most similar to the current block may refer to a block highly relevant to a pixel property and a position of the current block.

When the viewpoint prediction vector is extracted, the index transmitter 202 may transmit, through a bitstream, an index for identifying the viewpoint prediction vector of the current block to the multi-view video decoding device.

### Example Embodiment 4

The prediction vector determiner 201 may extract a spatial prediction vector, a temporal prediction vector, and a viewpoint prediction vector of the current block to be encoded.

The index transmitter 202 may transmit, through a bitstream, an index for identifying a final prediction vector determined for encoding the current block, from among the spatial prediction vector, the temporal prediction vector, and the viewpoint prediction vector of the current block to the multi-view decoding video device 102. In an example, the index transmitter 202 may transmit an index for identifying a prediction vector having an optimal encoding performance from among the spatial prediction vector, the temporal prediction vector, and the viewpoint prediction vector, based on at least one of a threshold value, a distance of a prediction vector, a bit quantity required for performing compression on a prediction vector, a degree of picture quality degradation when performing compression on a prediction vector, and a cost function when performing compression on a prediction vector.

According to the aforementioned example embodiments, information to be included in a bitstream may vary based on an encoding mode of the current block.

When the current block is encoded based on a skip mode, the index for identifying the spatial prediction vector, the temporal prediction vector, or the viewpoint prediction vector may be transmitted through a bitstream. Here, when the current block is included in a P-frame, the index may indicate a skip mode associated with the current block. When the current block is included in a B-frame, the index may indicate a direct skip mode included in a direct mode associated with the current block.

When the current block is encoded based on an encoding mode, for example, an inter-mode, rather than the skip mode, a residual signal, for example, a difference between a prediction block indicated by a prediction vector and the current block as well as the index for identifying the spatial prediction vector, the temporal prediction vector, or the viewpoint prediction vector may be included in a bitstream. Here, an encoding performance with respect to the current block may be enhanced because the more similar the prediction block and the current block, the less number of bits required for encoding the residual signal.

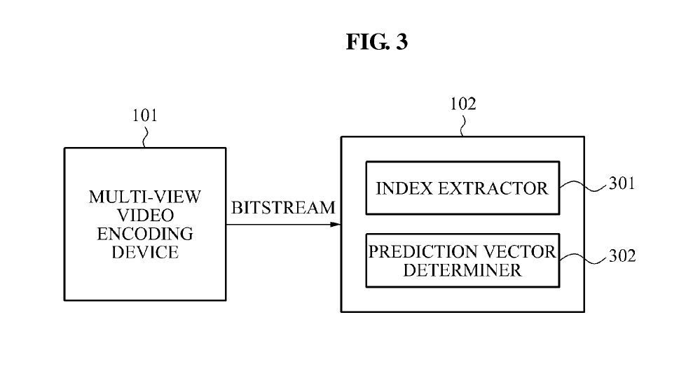

FIG. 3 is a block diagram illustrating a detailed configuration of a multi-view video decoding device 102 according to example embodiments.

Referring to FIG. 3, the multi-view video decoding device 102 may include an index extractor 301 and a prediction vector determiner 302.

Hereinafter, the multi-view video decoding device 102 operated based on four example embodiments will be discussed.

### Example Embodiment 1

The index extractor 301 may extract an index of a prediction vector from a bitstream received from the multi-view video encoding device 101. The prediction vector determiner 302 may determine a spatial prediction vector to be a final prediction vector for recovering a current block, based on the index.

In an example, the spatial prediction vector may include at least one of a first MV corresponding to a left block of the current block, a second MV corresponding to an upper block of the current block, a third MV corresponding to an upper left block of the current block, a fourth MV corresponding to an upper right block of the current block, and a fifth MV obtained by applying a median filter to the first MV, the second MV, the third MV, and the fourth MV.

In another example, the spatial prediction vector may include at least one of a first DV corresponding to a left block of the current block, a second DV corresponding to an upper block of the current block, a third DV corresponding to an upper left block of the current block, a fourth DV corresponding to an upper right block of the current block, and a fifth DV obtained by applying a median filter to the first DV, the second DV, the third DV, and the fourth DV.

### Example Embodiment 2

The index extractor 301 may extract an index of a prediction vector from a bitstream received from the multi-view video encoding device 101. The prediction vector determiner 302 may determine a temporal prediction vector to be a final prediction vector for recovering the current block, based on the index.

For one example, the temporal prediction vector may include an MV or a DV of a target block disposed at a position identical to a position of the current block in a frame corresponding to a time different from a time of a frame including the current block. In particular, when the current block is located at (x, y) coordinates of a frame 1, the temporal prediction vector of the current block may include an MV or a DV of a target block located at (x, y) coordinates of a frame 2 for which a time differs from a time of the frame 1.

In another example, the temporal prediction vector may include an MV or a DV of surrounding blocks adjacent to a target block disposed at a position identical to a position of the current block in a frame corresponding to a time different from a time of a frame including the current block. In particular, when the current block is located at (x, y) coordinates of the frame 1, the temporal prediction vector of the current block may include an MV or a DV of surrounding blocks adjacent to a target block located at (x, y) coordinates of the frame 2 for which a time differs from a time of the frame 1. Here, the surrounding blocks may include an upper block of the target block, a left block of the target block, an upper right block of the target block, or an upper left block of the target block.

In still another example, the temporal prediction vector may include an MV or a DV of a target block most similar to the current block in a frame corresponding to a time different from a time of a frame including the current block. Here, the target block most similar to the current block may refer to a block highly relevant to a pixel property and a position of the current block.

### Example Embodiment 3

The index extractor 301 may extract an index of a prediction vector from a bitstream received from the multi-view video encoding device 101. The prediction vector determiner 302 may determine a viewpoint prediction vector to be a final prediction vector for recovering the current block, based on the index.

In an example, the viewpoint prediction vector may include an MV or a DV of a target block disposed at a position identical to a position of the current block in a frame corresponding to a viewpoint different from a viewpoint of a frame including the current block. In particular, when the current block is located at (x, y) coordinates of a frame 1, the viewpoint prediction vector of the current block may include an MV or a DV of a target block located at (x, y) coordinates of a frame 2 of which a viewpoint differs from a viewpoint of the frame 1.

In another example, the viewpoint prediction vector may include an MV or a DV of surrounding blocks adjacent to a target block disposed at a position identical to a position of the current block in a frame corresponding to a viewpoint different from a viewpoint of a frame including the current block. In particular, when the current block is located at (x, y) coordinates of a frame 1, the viewpoint prediction vector of the current block may include an MV or a DV of surrounding blocks adjacent to a target block located at (x, y) coordinates of a frame 2 for which a time differs from a time of the frame 1. Here, the surrounding blocks may include an upper block of the target block, a left block of the target block, an upper right block of the target block, or an upper left block of the target block.

In still another example, the viewpoint prediction vector may include an MV or a DV of a target block most similar to the current block in a frame corresponding to a viewpoint different from a viewpoint of a frame including the current block. Here, the target block most similar to the current block may refer to a block highly relevant to a pixel property and a position of the current block.

### Example Embodiment 4

The index extractor 301 may extract an index of a prediction vector from a bitstream received from the multi-view encoding device 101. The prediction vector determiner 302 may determine a final prediction vector for recovering the current block, from among the spatial prediction vector, the temporal prediction vector, and the viewpoint prediction vector, based on the index.

In an example, the index transmitter 202 may transmit an index for identifying a prediction vector having an optimal encoding performance from among the spatial prediction vector, the temporal prediction vector, and the viewpoint vector, based on at least one of a threshold value, a distance of the prediction vector, a bit quantity required for performing compression on a prediction vector, and a degree of picture quality degradation when performing compression on a prediction vector, and a cost function when performing compression on a prediction vector.

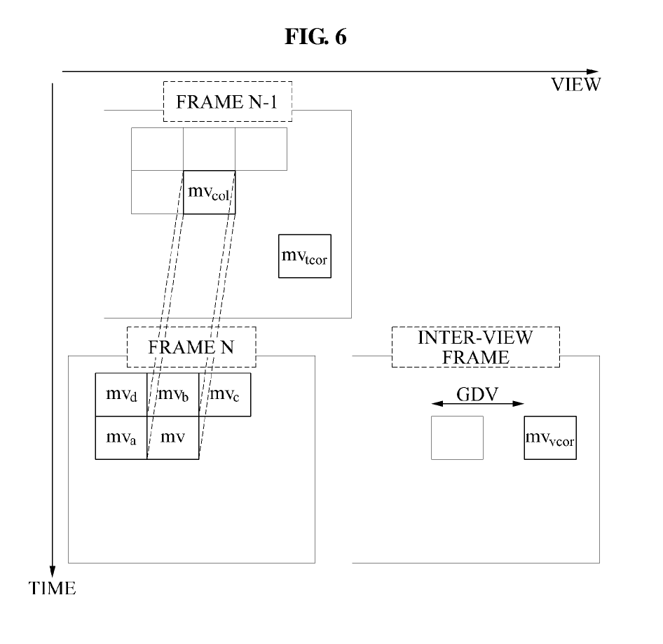

The spatial prediction vector, the temporal prediction vector, and the viewpoint prediction vector will be described in detail with reference to FIG. 6.

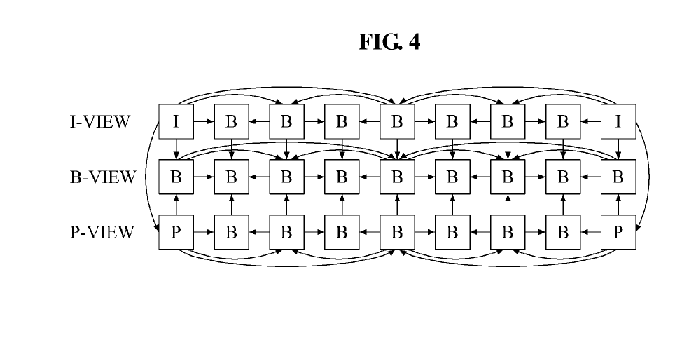

FIG. 4 is a diagram illustrating a structure of a multi-view video according to example embodiments.

Referring to FIG. 4, a multi-view video encoding method that encodes a picture of three viewpoints, for example, left, center, and right, to a group of pictures (GOP) “8” is illustrated when the picture of three viewpoints are input. Redundancy among pictures may be reduced because a hierarchical B picture is generally applied to a temporal axis and a viewpoint axis to encode a multi-view picture.

Based on the structure of the multi-view video of FIG. 4, the multi-view video encoding device 101 may encode a left picture, for example, I-view, a right picture, for example, P-view, and a center picture, for example, B-view, in a sequential manner, to encode the picture corresponding to the three viewpoints. In the present invention, a frame and a picture may be used interchangeably.

Here, the left picture may be encoded in a manner in which temporal redundancy is removed by searching for a similar area from previous pictures through motion estimation. The right picture may be encoded in a manner in which temporal redundancy based on the motion estimation and inter-viewpoint redundancy based on disparity estimation are removed because the right picture is encoded using the encoded left picture as a reference picture. Also, the center picture may be encoded in a manner in which inter-viewpoint redundancy is removed based on the disparity estimation in both directions because the center picture is encoded using both the encoded left picture and the right picture as a reference.

Referring to FIG. 4, in the multi-view video encoding method, I-view, for example, the left picture, refers to a picture to be encoded without using a reference picture of different viewpoints, P-view, for example, the right picture, refers to a picture to be encoded through predicting a reference picture of different viewpoints in a single direction, and B-view, for example, the center picture, refers to a picture to be encoded through predicting a reference picture of left and right viewpoints in both directions.

A frame of a model-view-controller (MVC) may be classified into 6 groups based on a prediction structure. More particularly, the 6 groups may include an I-viewpoint anchor frame for intra-encoding, an I-viewpoint non-anchor frame for inter-temporal inter-encoding, a P-viewpoint anchor frame for inter-viewpoint one-way inter-encoding, a P-viewpoint non-anchor frame for inter-viewpoint one-way inter-encoding and inter-temporal two-way inter-encoding, a B-viewpoint anchor frame for inter-viewpoint two-way inter-encoding, and a B-viewpoint non-anchor frame for inter-viewpoint two-way inter-encoding and inter-temporal both-way inter-encoding.

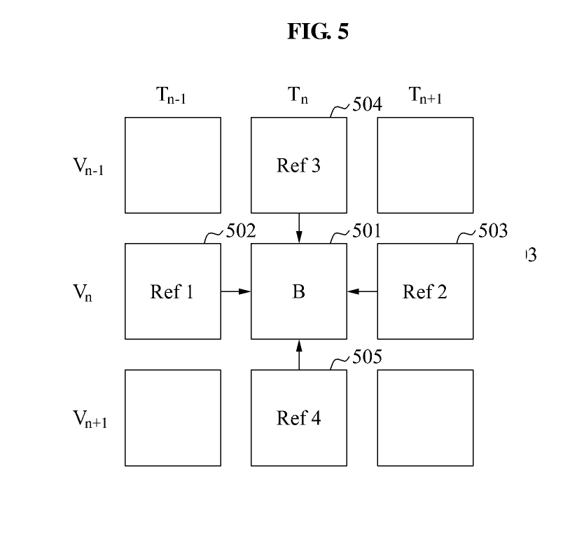

FIG. 5 is a diagram illustrating an example of a reference picture to be used for encoding a current block according to example embodiments.

The multi-view video encoding device 101 may use reference pictures 502 and 503 disposed around a time of a current frame and reference pictures 504 and 505 disposed around a viewpoint of the current frame when encoding a current block disposed at the current frame, for example, a current picture 501. More particularly, the multi-view video encoding device 101 may encode a residual signal between the current block and a prediction block, through searching for a prediction block most similar to the current block from among the reference pictures 502 through 505. The multi-view video encoding device 101 may use the Ref 1 picture 502 and the Ref 2 picture 503 for which a time differs from a time of the current frame including the current block in order to search for a prediction block, based on an MV. Additionally, the multi-view video encoding device 101 may use the Ref 3 picture 504 and the Ref 4 picture 505 for which a viewpoint differs from a viewpoint of the current frame including the current block in order to search for a prediction block, based on a DV.

FIG. 6 is a diagram illustrating a type of a prediction vector corresponding to a current block according to example embodiments.

According to example embodiments, the multi-view video encoding device 101 may encode a multi-view video through the following process. However, the following process may be applied to example embodiments 4 of FIGS. 2 and 3, and for example embodiments 1 through 3, a process of calculating an encoding performance may be omitted to select at least one of the MV and the DV to be used for competition.

(1) Select a reference picture

(2) Determine prediction vectors through extraction (based on a prediction structure)

(3) Predict an MV or a DV

(4) Estimate an MV or a DV

(5) Encode through use of a residual signal and encode motion/disparity information entropy (however, this step will be omitted when an encoding mode is SKIP (DIRECT))

(6) Calculate an encoding performance, for example, a rate-distortion (RD) cost

According to example embodiments, the multi-view video encoding device 101 may encode a current block through selecting a prediction vector corresponding to a current block, for example, a prediction vector having an optimal encoding performance from among a spatial prediction vector, a temporal prediction vector, and a viewpoint prediction vector. In particular, the multi-view video encoding device 101 may select the prediction vector having the optimal encoding performance, based on competition among prediction vectors.

The prediction vectors may be classified into three groups, for example, a spatial prediction vector, a temporal prediction vector, and a viewpoint prediction vector. The prediction vector as shown in FIG. 6 may be classified into three groups as shown in Table 1.

TABLE 1

| | Space (Ps) | Time (Pt) | Viewpoint (Pv) |
|---|---|---|---|
| Prediction vector | mv_{med}, mvₐ, mv_{b}, | mv_{col1}, mv_{col2}, | mv_{gdv1}, mv_{gdv2}, |
| (MV) | mv_{c}, mv_{d} | mv_{tcor}, | mv_{vcor} |
| Prediction vector | dv_{med}, dvₐ, dv_{b}, | dv_{col1}, dv_{col2}, | dv_{gdv1}, dv_{gdv2}, |
| (DV) | dv_{c}, dv_{d} | dv_{tcor}, | dv_{vcor} |

The spatial vector may refer to an MV or a DV corresponding to at least one surrounding block adjacent to a current block to be encoded.

In an example, the spatial prediction vector may include at least one of a first MV (mvₐ) corresponding to a left block of the current block, a second MV (mv_{b}) corresponding to an upper block of the current block, a third MV (mv_{d}) corresponding to an upper left block of the current block, a fourth MV (mv_{c}) corresponding to an upper right block of the current block, and a fifth MV (mv_{med}) obtained by applying a median filter to the first MV, the second MV, the third MV, and the fourth MV.

Also, the spatial prediction vector may include at least one of a first DV (dvₐ) corresponding to a left block of the current block, a second DV (dv_{b}) corresponding to an upper block of the current block, a third DV (dv_{d}) corresponding to an upper left block of the current block, a fourth DV (dv_{c}) corresponding to an upper right block of the current block, and a fifth DV (dv_{med}) obtained by applying a median filter to the first DV, the second DV, the third DV, and the fourth DV.

The temporal prediction vector may be determined based on a previous frame, for example, Frame N−1, disposed at a time prior to a time of a current frame, for example, Frame N, including the current block to be encoded.

For one example, the temporal prediction vector may include an MV (mv_{col1}) or a DV (dv_{col1}) of a target block disposed at a (x, y) position identical to a position of the current block in a previous frame, for example, Frame N−1, disposed at a time prior to a time of a current frame, for example, Frame N, including the current block to be encoded.

In another example, the temporal prediction vector may include an MV (mv_{col2}) or a DV (dv_{col2}) of at least one surrounding block adjacent to a target block disposed at a position identical to a position of the current block in a previous frame. Here, the at least one surrounding block may include a left block, an upper left block, an upper block, and an upper right block of the target block.

In still another example, the temporal prediction vector may include an MV (mv_{tcor}) or a DV (dv_{tcor}) of a target block most similar to the current block in a previous frame.

The viewpoint prediction vector may be determined based on an inter-view frame indicating a viewpoint different from a viewpoint of a current frame, for example, Frame N, including the current block to be encoded.

In an example, the viewpoint prediction vector may include an MV (mv_{gdv1}) or a DV (dv_{gdv1}) of a target block disposed at a position identical to a position of the current block in an inter-view frame corresponding to a viewpoint different from a viewpoint of the current frame including the current block to be encoded.

In another example, the viewpoint prediction vector may include an MV (mv_{gdv2}) or a DV (dv_{gdv2}) of surrounding blocks adjacent to a target block disposed at a position identical to a position of the current block in an inter-view frame corresponding to a viewpoint different from a viewpoint of the current frame including the current block to be encoded.

In still another example, the viewpoint prediction vector may include an MV (mv_{vcor}) or a DV (dv_{vcor}) of a target block most similar to the current block in an inter-view frame corresponding to a viewpoint different from a viewpoint of the current frame including the current block to be encoded.

According to example embodiments, an MV may refer to a vector indicating a predetermined block, for example, a target block or surrounding blocks adjacent to the target block, included in a previous frame indicating a viewpoint identical to a viewpoint of a current frame including a current block, or a time different from a time of the current frame including the current block. Here, the previous frame may refer to a reference picture of the current block.

A DV may refer to a vector indicating a predetermined block, for example, a target block or surrounding blocks adjacent to the target block, included in an inter-view frame indicating a viewpoint identical to a viewpoint of a current frame including a current block, or a time different from a time of the current frame including the current block. Here, the inter-view frame may refer to a reference picture of the current block.

According to example embodiments, a multi-view video encoding device may extract at least one of a spatial prediction vector, a temporal prediction vector, and a viewpoint prediction vector with respect to a current block to be encoded.

Here, when the spatial prediction vector, the temporal prediction vector, and the viewpoint prediction vector with respect to the current block to be encoded are extracted, the multi-view video encoding device may select a prediction vector to be used for final encoding through a competition process among prediction vectors. The multi-view video encoding device 101 may extract a prediction vector having an optimal encoding performance from among the extracted prediction vectors.

In an example, the prediction vector determiner 202 may determine a prediction vector having an optimal encoding performance, based on at least one of (1) a threshold value, (2) a distance between a finally determined MV/DV and a prediction vector, (3) a bit quantity required for performing compression on a prediction vector, and a degree of picture quality degradation when performing compression on a prediction vector, and (4) a cost function when performing compression on a prediction vector.

Here, the cost function may be determined based on Equation 1.

RD Cost=SSD(s,r)+λ*R(s,r,mode) [Equation 1]

Here, a sum of square difference (SSD) denotes a squared value of differential values of a current block (s) and a prediction block (r) based on a prediction vector, and λ denotes a Lagrangian coefficient. R denotes a number of bits required when a signal obtained by a differential value of a current frame to be encoded to an encoding mode and a reference frame derived from motion prediction or disparity prediction is encoded. Also, R may include an index bit indicating a type of prediction vector.

Generating an index bit through binarizing an index of a prediction vector may be important in order to encode competition-based motion information or disparity information. The index bit may be defined by Table 2. When candidates of a spatial prediction vector, a temporal prediction vector, and a viewpoint prediction vector are identical to one another, the multi-view video encoding device 101 may not transmit the index bit to the multi-view video decoding device 102.

TABLE 2

| | | | |
|---|---|---|---|
| 2 prediction vectors | Index | 0 | 1 |
| | Binary code | 0₂ | 1₂ |

| | | | | |
|---|---|---|---|---|
| 3 prediction vectors | Index | 0 | 1 | 2 |
| | Binary code | 0₂ | 10₂ | 11₂ |

| | | | | | |
|---|---|---|---|---|---|
| 4 prediction vectors | Index | 0 | 1 | 2 | 3 |
| | Binary code | 0₂ | 10₂ | 110₂ | 111₂ |

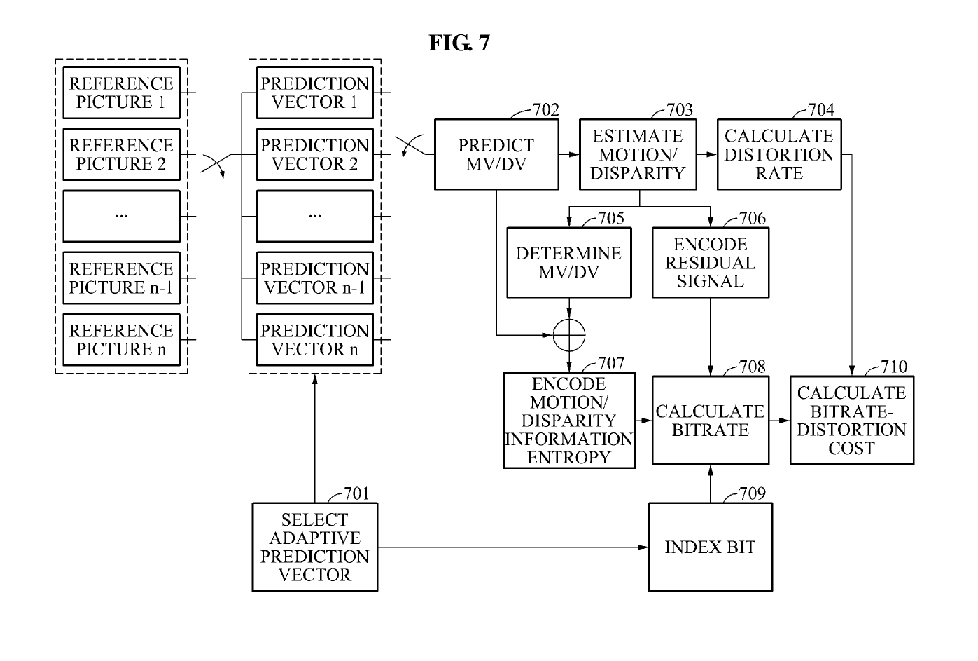

FIG. 7 is a diagram illustrating a multi-view video encoding device operating in an inter-mode/intra-mode according to example embodiments.

Referring to FIG. 7, the inter-mode/intra-mode may refer to encoding a residual signal, for example, a difference between a current block to be encoded and a prediction block indicated by an MV extracted through motion prediction. The inter-mode may refer to a prediction block to be disposed at a frame different from a frame of a current block, and the intra-mode may refer to a current block and a prediction block to be disposed at an identical frame. Here, the spatial prediction vector may be used for encoding to the intra-mode, and a temporal prediction vector and a viewpoint prediction vector may be used for encoding to the inter-mode.

The multi-view video encoding device 101 may extract a prediction vector corresponding to a current block to be encoded. Here, the prediction vector may include at least one of a spatial prediction vector, a temporal prediction vector, and a viewpoint prediction vector.

When more than 2 prediction vectors are extracted, the multi-view video encoding device 101 may encode an input image using a final prediction vector extracted based on competition among prediction vectors. More particularly, the multi-view video encoding device 101 may select a final prediction vector having an optimal encoding performance from among the spatial prediction vector, the temporal prediction vector, and the viewpoint prediction vector, and determine a final prediction vector for encoding a current frame to be encoded. The multi-view video encoding device 101 may encode a current block, based on a reference frame indicated by a prediction vector.

The multi-view video encoding device 101 may transmit a bitstream of a multi-view video to the multi-view video decoding device 102, as a result of the encoding. The multi-view video encoding device 101 may transmit, through a bitstream, the index bit indicating the type of prediction vector used for encoding the multi-view video to the multi-view video decoding device 102.

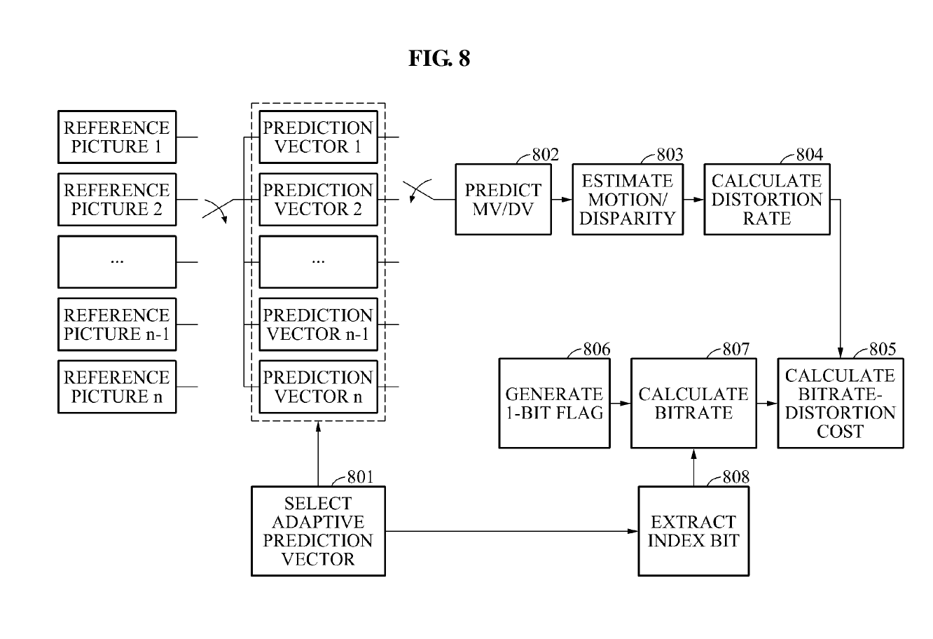

FIG. 8 is a diagram illustrating a multi-view video encoding device operating in a skip mode according to example embodiments.

The multi-view video encoding device 101 may not encode a residual signal when compared to the multi-view video encoding device of FIG. 7. In particular, the multi-view video encoding device 101 of FIG. 8 may not encode a residual signal, for example, a difference between a prediction block derived through motion prediction or disparity prediction and a current block. Alternatively, the multi-view video encoding device 101 may include information, for example, an index bit, indicating that a current block is encoded based on a skip mode in a bitstream to transmit the bitstream including the index bit to the multi-view video encoding device 102.

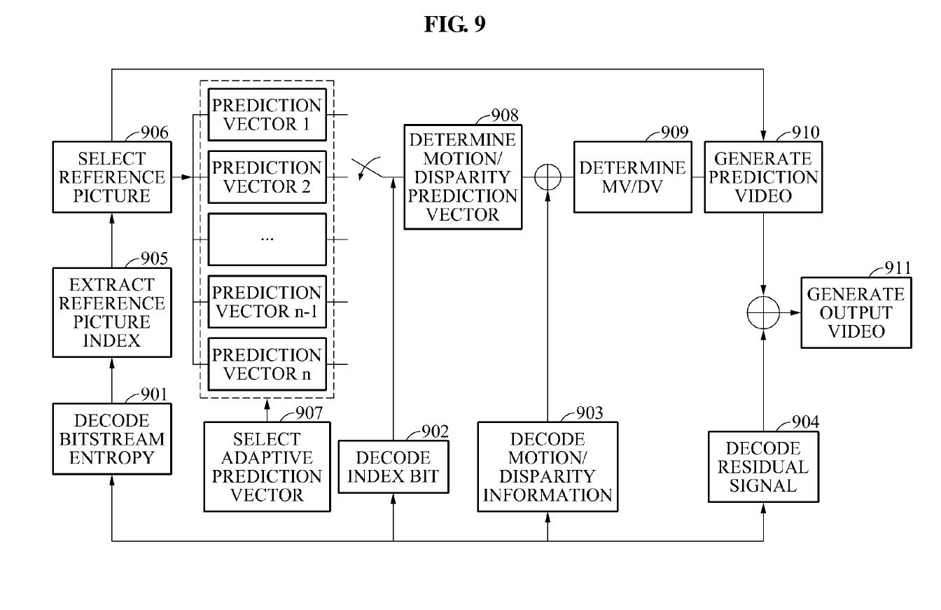

FIG. 9 is a diagram illustrating a multi-view video decoding device operating in an inter-mode/intra-mode according to example embodiments.

Referring to FIG. 9, a bitstream transmitted via the multi-view video encoding device 101 may include encoding information on a block to be recovered and a residual signal with respect to a block.

For example, when a current block to be recovered is encoded in an inter-mode/intra-mode, the multi-view video decoding device 102 may extract a prediction vector associated with a current block. Here, the prediction block associated with the current block may be determined based on the index bit included in the bitstream. The multi-view video decoding device 102 may generate a prediction video through performing motion compensation or disparity compensation on the current block, based on the prediction vector, and generate a final output video through combining the prediction video with the residual signal included in the bitstream. Here, the prediction vector may refer to at least one of the spatial prediction vector, the temporal prediction vector, and the viewpoint prediction vector.

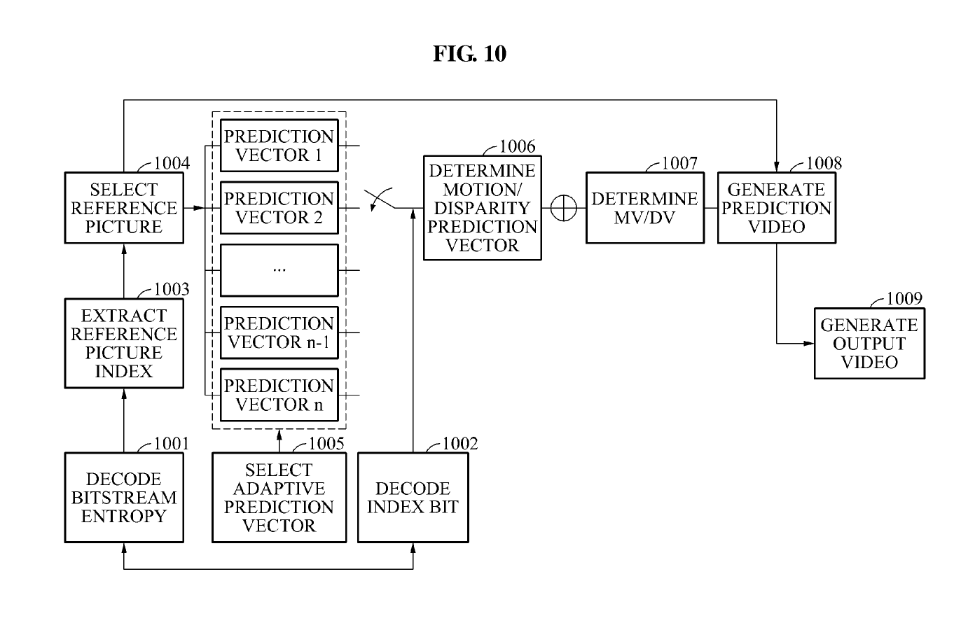

FIG. 10 is a diagram illustrating a multi-view video decoding device operating in a skip mode according to example embodiments.

The multi-view video decoding device 102 may generate a prediction video through performing motion compensation or disparity compensation, based on a prediction vector associated with a current block to be recovered. Here, the prediction vector may be determined based on an index bit of the current block included in a bitstream.

The prediction video generated in the multi-view video decoding device 102 may be an output video as is because a current block encoded in a skip mode is encoded without a residual signal being transmitted.

Example embodiments include computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts. Examples of computer-readable media include magnetic media such as hard disks, floppy disks, and magnetic tape; optical media such as CD ROM discs; magneto-optical media such as floptical discs; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A multi-view video encoding device, the device comprising:
a prediction vector extractor to extract a spatial prediction vector of a current block to be encoded; and
an index transmitter to transmit, through a bitstream, an index for identifying the spatial prediction vector of the current block to a multi-view video decoding device.

2. The device of claim 1, wherein the spatial prediction vector comprises at least one of:
a first motion vector (MV) corresponding to a left block of the current block, a second MV corresponding to an upper block of the current block, a third MV corresponding to an upper left block of the current block, a fourth MV corresponding to an upper right block of the current block, and a fifth MV obtained by applying a median filter to the first MV, the second MV, the third MV, and the fourth MV.

3. The device of claim 1, wherein the spatial prediction vector comprises at least one of:
a first disparity vector (DV) corresponding to a left block of the current block, a second DV corresponding to an upper block of the current block, a third DV corresponding to an upper left block of the current block, a fourth DV corresponding to an upper right block of the current block, and a fifth DV obtained by applying a median filter to the first DV, the second DV, the third DV, and the fourth DV.

4. A multi-view video encoding device, the device comprising:
a prediction vector extractor to extract a temporal prediction vector of a current block to be encoded; and
an index transmitter to transmit, through a bitstream, an index for identifying the temporal prediction vector of the current block to a multi-view video decoding device.

5. The device of claim 4, wherein the temporal prediction vector comprises:
a motion vector (MV) or a disparity vector (DV) of a first target block disposed at a position identical to a position of the current block in a frame corresponding to a time different from a time of a frame including the current block.

6. The device of claim 4, wherein the temporal prediction vector comprises:
an MV or a DV of surrounding blocks adjacent to the first target block disposed at a position identical to a position of the current block in a frame corresponding to a time different from a time of a frame including the current block.

7. The device of claim 4, wherein the temporal prediction vector comprises:
an MV or a DV of a second target block most similar to the current block in a frame corresponding to a time different from a time of a frame including the current block.

8. A multi-view video encoding device, the device comprising:
a prediction vector extractor to extract a viewpoint prediction vector of a current block to be encoded; and
an index transmitter to transmit, through a bitstream, an index for identifying the viewpoint prediction vector of the current block to a multi-view video decoding device.

9. The device of claim 8, wherein the viewpoint prediction vector comprises:
an MV or a DV of a first target block disposed at a position identical to a position of the current block in a frame corresponding to a viewpoint different from a viewpoint of a frame including the current block.

10. The device of claim 8, wherein the viewpoint prediction vector comprises:
an MV or a DV of surrounding blocks adjacent to the first target block disposed at a position identical to a position of the current block in a frame corresponding to a viewpoint different from a viewpoint of a frame including the current block.

11. The device of claim 8, wherein the viewpoint prediction vector comprises:
an MV or a DV of a second target block most similar to the current block in a frame corresponding to a viewpoint different from a viewpoint of a frame including the current block.

12. A multi-view video encoding device, the device comprising:
a prediction vector extractor to extract a spatial prediction vector of a current block to be encoded, a temporal prediction vector, and a viewpoint prediction vector; and
an index transmitter to transmit, through a bitstream, an index for identifying a prediction vector to be used in encoding the current block from among the spatial prediction vector of the current block to be encoded, the temporal prediction vector, and the viewpoint prediction vector to a multi-view video decoding device.

13. The device of claim 12, wherein the index transmitter transmits an index for identifying a prediction vector having an optimal encoding performance from among the spatial prediction vector of the current block to be encoded, the temporal prediction vector, and the viewpoint prediction vector, based on at least one of a threshold value, a distance of a prediction vector, a bit quantity required for performing compression on a prediction vector, a degree of picture quality degradation when performing compression on a prediction vector, and a cost function when performing compression on a prediction vector.

14. A multi-view video decoding device, the device comprising:
an index extractor to extract an index of a prediction vector from a bitstream received from a multi-view video encoding device; and
a prediction vector determiner to determine a spatial prediction vector to be a final prediction vector for recovering a current block, based on the index.

15. The device of claim 14, wherein the spatial prediction vector comprises at least one of:
a first motion vector (MV) corresponding to a left block of the current block, a second MV corresponding to an upper block of the current block, a third MV corresponding to an upper left block of the current block, a fourth MV corresponding to an upper right block of the current block, and a fifth MV obtained by applying a median filter to the first MV, the second MV, the third MV, and the fourth MV.

16. The device of claim 14, wherein the spatial prediction vector comprises at least one of:
a first disparity vector (DV) corresponding to a left block of the current block, a second DV corresponding to an upper block of the current block, a third DV corresponding to an upper left block of the current block, a fourth DV corresponding to an upper right block of the current block, and a fifth DV obtained by applying a median filter to the first DV, the second DV, the third DV, and the fourth DV.

17. A multi-view video decoding device, the device comprising:
an index extractor to extract an index of a prediction vector from a bitstream received from a multi-view video encoding device; and
a prediction vector determiner to determine a temporal prediction vector to be a final prediction vector for recovering a current block, based on the index.

18. The device of claim 17, wherein the temporal prediction vector comprises:
a motion vector (MV) or a disparity vector (DV) of a first target block disposed at a position identical to a position of the current block in a frame corresponding to a time different from a time of a frame including the current block.

19. The device of claim 17, wherein the temporal prediction vector comprises:
an MV or a DV of surrounding blocks adjacent to the first target block disposed at a position identical to the current block in a frame corresponding to a time different from a time of a frame including the current block.

20. The device of claim 17, wherein the temporal prediction vector comprises:
an MV or a DV of a second target block most similar to the current block in a frame corresponding to a time different from a time of a frame including the current block.

21. A multi-view video decoding device, the device comprising:
an index extractor to extract an index of a prediction vector from a bitstream received from a multi-view video encoding device; and
a prediction vector determiner to determine a viewpoint prediction vector to be a final prediction vector for recovering a current block, based on the index.

22. The device of claim 21, wherein the viewpoint prediction vector comprises:
a motion vector (MV) or a disparity vector (DV) of a first target block disposed at a position identical to a position of the current block in a frame corresponding to a viewpoint different from a viewpoint of a frame including the current block.

23. The device of claim 21, wherein the viewpoint prediction vector comprises:
an MV or a DV of surrounding blocks adjacent to the first target block disposed at a position identical to a position of the current block in a frame corresponding to a viewpoint different from a viewpoint of a frame including the current block.

24. The device of claim 21, wherein the viewpoint prediction vector comprises:
an MV or a DV of a second target block most similar to the current block in a frame corresponding to a viewpoint different from a viewpoint of a frame including the current block.

25. A multi-view video decoding device, the device comprising:
an index extractor to extract an index of a prediction vector from a bitstream received from a multi-view video encoding device; and
a prediction vector determiner to determine a final prediction vector for recovering a current block from among a spatial prediction vector, a temporal prediction vector, and a viewpoint prediction vector, based on the index.

26. The device of claim 25, wherein the index transmitter transmits an index for identifying a prediction vector having an optimal encoding performance from among the spatial prediction vector, the temporal prediction vector, and the viewpoint prediction vector, based on at least one of a threshold value, a distance of a prediction vector, a bit quantity required for performing compression on a prediction vector, a degree of picture quality degradation when performing compression on a prediction vector, and a cost function when performing compression on a prediction vector.

27. A multi-view video encoding method, the method comprising:
extracting a spatial prediction vector of a current block to be encoded; and
transmitting, through a bitstream, an index for identifying the temporal prediction vector of the current block to a multi-view video decoding device.

28. A multi-view video encoding method, the method comprising:
extracting a temporal prediction vector of a current block to be encoded; and
transmitting, through a bitstream, an index for identifying the temporal prediction vector of the current block to a multi-view video decoding device.

29. A multi-view video encoding method, the method comprising:
extracting a viewpoint prediction vector of a current block to be encoded; and
transmitting, through a bitstream, an index for identifying the viewpoint prediction vector of the current block to a multi-view video decoding device.

30. A multi-view video encoding method, the method comprising:
extracting a spatial prediction vector of a current block to be encoded, a temporal prediction vector, and a viewpoint prediction vector; and
transmitting, through a bitstream, an index for identifying a prediction vector to be used in encoding the current block from among the spatial prediction vector of the current block to be encoded, the temporal prediction vector, and the viewpoint prediction vector to a multi-view video decoding device.

31. A multi-view video decoding method, the method comprising:
extracting an index of a prediction vector from a bitstream received from a multi-view video encoding device; and
determining a spatial prediction vector to be a final prediction vector for recovering a current block, based on the index.

32. A multi-view video decoding method, the method comprising:
extracting an index of a prediction vector from a bitstream received from a multi-view video encoding device; and
determining a temporal prediction vector to be a final prediction vector for recovering a current block, based on the index.

33. A multi-view video decoding method, the method comprising:
extracting an index of a prediction vector from a bitstream received from a multi-view video encoding device; and
determining a viewpoint prediction vector to be a final prediction vector for recovering a current block, based on the index.

34. A multi-view video decoding method, the method comprising:
extracting an index of a prediction vector from a bitstream received from a multi-view video encoding device; and
determining a final prediction vector for recovering a current block from among a spatial prediction vector, a temporal prediction vector, and a viewpoint prediction vector, based on the index.

35. A non-transitory computer-readable medium comprising a program for instructing a computer to perform the method of claim 27.
